(19) United States
(12) Patent Application Publication
(10) Pub. No.: US 2024/0362539 A1
(43) Pub. Date: Oct. 31, 2024

(54) MACHINE LEARNING PIPELINE FOR DEPLOYING SCALABLE DISTRIBUTED SYSTEMS USING A LARGE LANGUAGE MODEL

(71) Applicant: Nokia Solutions and Networks Oy, Espoo (FI)

(72) Inventors: Manuel STEIN, Stuttgart (DE); Giacomo LANCIANO, Stuttgart (DE); Volker HILT, Stuttgart (DE)

(21) Appl. No.: 18/646,009

(22) Filed: Apr. 25, 2024

Related U.S. Application Data
(60) Provisional application No. 63/498,280, filed on Apr. 26, 2023.

(51) Int. Cl. G06N 20/00

(52) U.S. Cl. CPC G06N 20/00

(57) ABSTRACT

In various aspects systems and methods are provided for using a Large Language Model(s) to analyze declarative deployment code as found in deployment manifest files for deploying resources in a cloud-based environment.

### FIELD

The field relates generally to using machine learning large language models in the context of deploying scalable distributed systems in a cloud network environment.

### BACKGROUND

This section introduces aspects that may be helpful in facilitating a better understanding of the disclosure. Accordingly, the statements of this section are to be read in this light and are not to be understood as admissions about what is or is not in the prior art.

In the cloud-native era, developers have at their disposal a landscape of services to build scalable distributed systems. The DevOps paradigm emerged as a response to the increasing necessity of better automations, capable of dealing with the complexity of modern cloud systems. For instance, Infrastructure-as-Code tools provide a declarative way to define, track, and automate changes to the infrastructure underlying a cloud application. Assuring the quality of this part of a code base is of utmost importance. However, learning to produce robust deployment specifications is not an easy feat, and for the domain experts it is time consuming to conduct code-reviews and transfer the appropriate knowledge to other members of the team.

### SUMMARY

Given the abundance of data generated throughout the DevOps cycle, machine learning (ML) techniques seem a promising way to deploy scalable cloud network resources.

Illustrative embodiments provide for an approach based on Large Language Models to evaluate declarative deployment code for deploying resources in a cloud network environment and automatically provide, for example, quality recommendations (e.g., classifications) to developers, such that they can benefit of established best practices and design patterns. More particularly, various embodiments are directed to a Machine Learning (ML) pipeline based on using a Large Language Machine learning model (LLM), which provides a framework for realizing one or more objectives/advantages as described in detail below.

In one illustrative embodiment, an apparatus is provided, where the apparatus includes at least one processor; and at least one memory storing instructions that, when executed by the at least one processor, cause the apparatus at least to implement one or more steps of a machine learning pipeline comprising:
extracting a dataset of one of more features from a set of manifest files for deploying resources in a cloud network environment;
clustering the dataset of one of more features extracted from the set of manifest files;
labelling the clustered dataset of the one or more features extracted from the manifest files; and,
using the labeled dataset to train a large language machine learning model.

In another aspect a method is provided wherein the method comprises:
extracting a dataset of one of more features from a set of manifest files for deploying resources in a cloud network environment;
clustering the dataset of one of more features extracted from the set of manifest files;
labelling the clustered dataset of the one or more features extracted from the manifest files; and,
using the labeled dataset to train a large language machine learning model.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a representative machine learning pipeline based on using a large language model in accordance with various aspects of the disclosure.

FIG. 2 illustrates an example apparatus with which one or more illustrative embodiments may be implemented.

FIGS. 3A-3B illustrates results of the clustering process, before and after filtering out the uninteresting manifest files. The clustered manifests are projected onto a 2D space by using t-SNE (i.e., the axes do not directly refer to any specific feature).

FIG. 4 illustrates an example of a prompt used for few-shot learning.

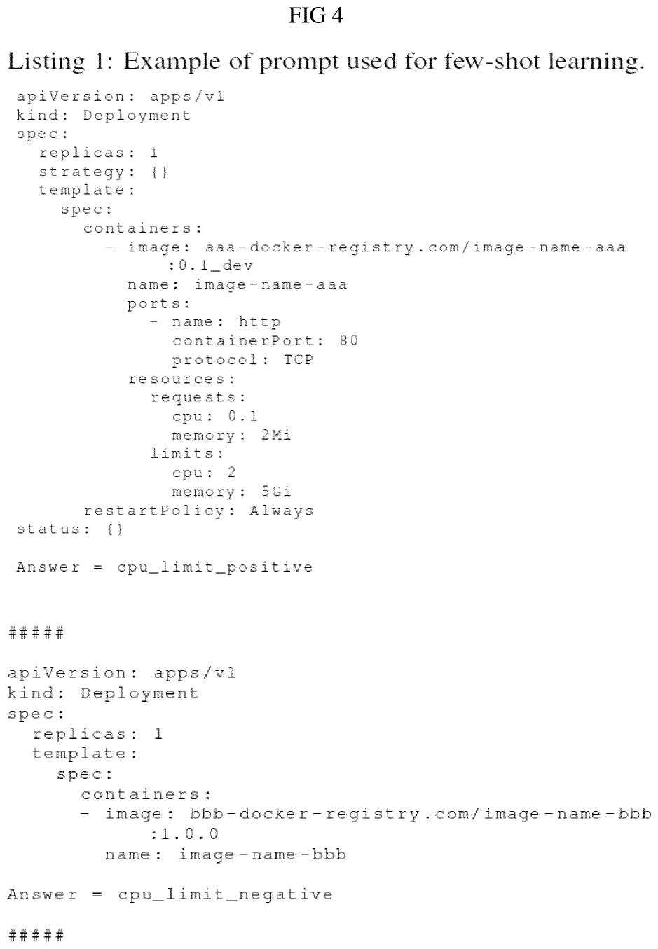

### DETAILED DESCRIPTION

Embodiments will be illustrated herein in conjunction with example systems and associated techniques for deploying scalable distributed systems in cloud network environment. It should be understood, however, that the scope of the claims is not limited to particular types of systems and/or processes disclosed, as will be readily understood by one of ordinary skill in the art.

During the last decade, cloud technologies have been evolving at an impressive pace, such that in a cloud-native era developers can leverage an unprecedented landscape of advanced services to build highly resilient distributed systems, providing computing, storage, networking, load-balancing, security, monitoring and orchestration functionality, among others. To keep up with this pace, development and operations practices have undergone very significant transformations, especially in terms of improving the automations that make releasing new software, and responding to unforeseen issues, faster and sustainable at scale. The resulting paradigm is commonly referred to as DevOps (Alnafessah et al., 2021).

Quality assurance (QA) is a fundamental part of the DevOps cycle. However, the complexity of modern cloud frameworks and services makes a developer's job considerably difficult. On top of that, development teams are typically composed by persons with very diverse backgrounds, and varying levels of expertise. This variance makes adhering to best practices anything but straightforward, because transferring knowledge from experts to novice/other members takes a considerable amount of time. Therefore, in line with the DevOps philosophy, automating this process as much as possible seems the right approach. Indeed, there exist a vast amount of tools that provide (static) code analysis functionality, and that can be seamlessly integrated in existing continuous-integration/continuous delivery (CI/CD) pipelines to address QA concerns.

However, given the impressive abundance of data generated throughout the DevOps cycle, applying machine learning (ML) techniques in this context seems a promising path towards providing developers with high-quality feedbacks and recommendations, automatically.

When developing a cloud-native application, the definition of its deployment plays a fundamental role. Modern cloud management frameworks, like Kubernetes and OpenStack (two of the most well-known open-source and widely adopted projects), typically offer at least an Infrastructure-as-Code (IaC) solution (e.g., deployment manifests and Heat templates, respectively, generally referenced herein as deployment manifests). Such solutions allow for specifying the desired properties and the relations among the components of the deployment via declarative code, that can then be versioned and treated in the same way as the code that implements the actual application logic. It is obviously very important to follow best practices when, e.g., specifying a Kubernetes deployment manifest, as failing to do so may lead application to experience many types of issues (Mumtaz et al., 2021; Li et al., 2022). Static analysis tools for manifest files, like for instance Polaris (1) or Kubesec, (2) allow for mitigating the risk that such issues may actually occur. However, they are typically designed to run relatively simplistic checks, that do not take into account complex design patterns.

The present disclosure describes an approach to declarative deployment code analysis based on using Large Language Models (LLMs), that can automatically provide QA-related recommendations to developers based on established best practices and design patterns and may be built on top of standard (static) analysis approaches.

Also, while various embodiments of the disclosure describe examples applied to deployment code, it is considered that aspects described herein could also be integrated with the other available data sources in the DevOps cycle, such as, for example, version control system history, code review feedbacks, tests measurements and logs, etc.

This disclosure is organized as follows.
Section 2 provides an overview of the existing related works in the space of code analysis with LLMs.
Section 3 presents a ML pipeline in accordance with various aspects of the disclosure.
Section 4 presents the results of experimental validation of the ML pipeline disclosed herein on a set of sampled Kubernetes manifest files.
Section 5 concludes with certain potential future research directions.

The present disclosure proposes the use of Natural Language Processing (NLP) models to detect architectural smells and issues in declarative deployment code.

### Section 2

Language models are nowadays extensively used in practice to analyze and generate source code (Sharma et al., 2021; MacNeil et al., 2022). In particular, we focus on LLMs, that are models based on the transformer architecture (Vaswani et al., 2017), consisting of millions, or even billions, of learnable parameters. During the last years, in fact, this class of models has been gaining a lot of attention from the research community, due to their fascinating emergent properties like unsupervised multitask (Radford et al., 2019) and few-shot (Brown et al., 2020) learning.

In (Zhang et al., 2021), the authors propose an LLM-based approach to automatically fix textual and semantic merge conflicts in a version-controlled codebase. Their approach leverages entirely on few-shot learning, and exhibits remarkable performance without requiring fine-tuning. In (Chen et al., 2021), the authors propose Codex, a GPT (Radford et al., 2018) model extensively fine-tuned on open-source code retrieved from GitHub, that exhibits remarkable performance in generating source code when prompted with the corresponding textual description. Similarly, in (Heyman et al., 2021), the authors propose an LLM-based approach to code generation that takes into account both the code already written by developers and their intent, expressed in plain natural language.

In particular, such model is empirically validated on Python code generation for data science applications. In (Shorten and Khoshgoftaar, 2023), KerasBERT is proposed. Such model is trained on a considerable amount of code examples, notebooks, blog posts and forum threads regarding the Keras deep learning framework, to provide an automatic tool to analyze and generate documentation for related code snippets. The authors of (Jain et al., 2022) propose Jigsaw, an approach based on program synthesis techniques, to post-process the source code generated by specialized LLMs in order to provide quality guarantees.

The work presented in (Thapa et al., 2022) demonstrates how LLMs can also be used for detecting software vulnerabilities. Indeed, the authors provide the results of an empirical analysis, conducted on vulnerability datasets for C/C++ source code, showing how LLMs outperform other neural models like those based on long short-term memory (LSTM) and gated recurrent units (GRUs). Similarly, the authors of (Demirci et al., 2022) propose a malware detection mechanism that leverages on a combination of LSTM and LLMs to discover malicious instructions in assembly code.

In (Ma et al., 2022), the authors investigate on the reasons behind the emergent capability of LLMs to learn code syntax and semantic. In particular, they rely on Abstract Syntax Trees (AST) and static analysis to deeply understand the role that the self-attention mechanism plays in learning the dependencies among code tokens. On a related note, in (Wan et al., 2022), the authors approach the problem of interpreting pretrained LLMs for code analysis. Remarkably, their results show that, in a transformer architecture, the code syntax structure is typically preserved in the intermediate representations of each layer and, as a result, that such LLMs are able to induce ASTs.

The authors of (Sarsa et al., 2022) empirically demonstrated how LLMs can be successfully used to generate, and explain, code for programming exercises that is both novel and reasonable. On the other hand, in (Sontakke et al., 2022), the authors provide evidence that the same type of models heavily rely on contextual cues (e.g., natural-language comments, or function names) and that, by masking such information, their summarization performance drops significantly.

The works referenced in this section generally use LLMs to either provide general-purpose code generation solutions (e.g., (Chen et al., 2021; Heyman et al., 2021)), or realize code analysis tools for specific programming languages and/or frameworks (e.g., (Thapa et al., 2022; Shorten and Khoshgoftaar, 2023)).

### Section 3

However, none of prior art solutions illustratively described above in Section 2 propose an approach to detect, or recommend, the usage of specific best-practices and high-level design patterns, that are very important for QA. Additionally, none of the aforementioned works provide a ML-based pipeline that specializes LLMs to analyze declarative deployment code that, nowadays, is ubiquitously used to configure modern cloud environments. In view of this, it is believed that the ML-based pipeline described herein addresses a very relevant technical problem and constitutes an innovative solution for efficiently improving deployment of scalable, distributed service and applications in a cloud network environment.

Various exemplary embodiments described herein focus on the analysis of Kubernetes deployment manifest files. In particular, a goal is to provide non-expert developers with recommendations regarding the (mis-)usage of relevant Kubernetes architectural patterns (e.g., the Operator pattern). In order to achieve the desired improvements, the present disclosure identifies the following fundamental features that the ML pipeline disclosed herein can be adapted to address:
Feature F1: Classifying good-and bad-quality manifests.
Feature F2: Explaining which characteristics contribute the most to the outcome of the classification.
Feature F3: Pinpointing design smells and issues, and possibly recommending a suitable fix.
Feature F4: Leveraging on the relations specified among the components to detect highly complex architectural patterns.

In one embodiment, it may be assumed (but is not a necessary assumption) that a (possibly small) set of annotated manifest examples is available. This is reasonable to assume in a scenario where DevOps teams conduct code reviews, such that useful annotations could even be automatically extracted from the platform used for such activities. Therefore, implementing F1 can be approached as a supervised learning classification problem. In this context, the notions of good and bad can be interpreted in many ways, also according to the nature of the available annotations. An expert developer can generally tell “at a glance” whether a manifest seems to be poorly written or not, although there are possibly many reasons why a specific manifest is problematic. In some embodiments the classification may be more than a simple binary classification.

Both F2 and F3 are concerned with augmenting the quality of the recommendations. However, while F2 refers to the possibility to apply specific techniques (Atanasova et al., 2020; Tenney et al., 2020; Hoover et al., 2020) to better interpret the output of an arbitrary model, F3 entails that such a model should be able to solve a more complex task than a simple classification, in order to provide the end user with fine-grained recommendations. Implementing both F2 and F3 inherently requires a trade-off to be made between the interpretability and the power/complexity of the underlying ML model.

Similarly, F4 is concerned with endowing the model with the capability of detecting more convoluted design patterns, that are not easily discoverable when looking at resources in isolation. Given the set of desired features, and the fact that the input data mainly consist in source code (or text, in general), we believe that LLMs are the most suitable tools to address our problem.

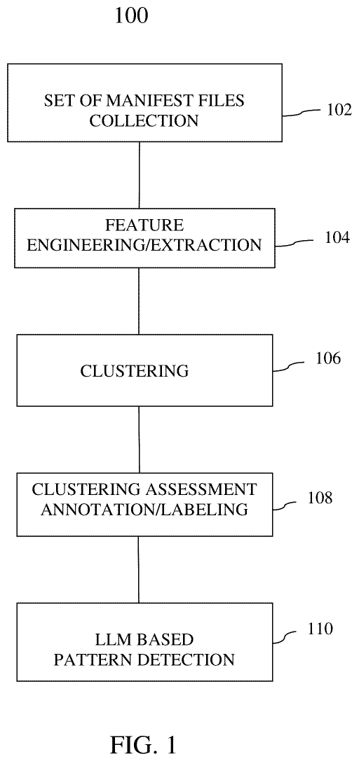

Turning now to process 100 of FIG. 1, an example of a ML pipeline in accordance with the present disclosure is illustrated for enabling/realizing one or more of the features described above in Section 3.

Step 102 of process 100 of FIG. 1 begins with a set of deployment manifest files for deployment of service/application resources in a cloud network environment. In one particular embodiment, the deployment manifest files are Kubernetes deployment manifest files. Nowadays, Kubernetes is one of the most used cloud orchestration framework, and definitely among the most important projects backed by the Cloud Native Computing Foundation (CNCF). Therefore, it is very easy to find large open-source collections of high-quality deployment manifest files, like by considering those from CNCF graduated and incubating projects. In other embodiments, the manifest files may be other type of deployment manifest files in the context of implementing/deploying cloud network-based applications, services, or resources.

Step 104 of process 100 of FIG. 1 includes feature engineering, in which steps one or more characteristics features of the manifest files may be identified and/or extracted. In this regard, it is noted that the main data quality related problem is represented by the scarcity of annotations that could be used to train supervised ML models. It is assumed that the set of manifest files are unannotated (i.e., unlabeled) manifest files, or some combination of unannotated and annotated manifest files. It should also be understood that this step may include a preprocessing step that may be used to filter and include and/or exclude one or more manifest files based on certain criteria, such as their impact (or lack of impact respectively) on the overall desired results.

To overcome the limitation of a lack or scarcity of annotations, step 106 of process 100 of FIG. 1 includes using an (unsupervised) clustering approach (e.g., HDBSCAN (McInnes and Healy, 2017)) to try and detect significant similarities among the manifests. In general, clustering approaches are not designed to handle textual data directly, so step 104 establishes a proper feature engineering process such that manifests are transformed into appropriate feature vectors, e.g., using, for example, standard tf-idf scores (Rajaraman and Ullman, 2011).

Although the vector representations generated in step 104 may be high-dimensional, the results of the clustering process of step 106 can enable easy visualization using embedding techniques, as made in t-SNE (Maatenand Hinton, 2008). These approaches are designed to project high-dimensional spaces onto 2 or 3 dimensions, while retaining the spatial relations among the data points as much as possible.

As a result, in step 108 of the ML pipeline of process 100 of FIG. 1, all or some representative clustered feature data may be annotated/labeled. Such annotation/labeling may be provided via manual inspection from the discovered clusters and, accordingly, in step 108 the process may include receiving a set of initial annotations from, for example, a human subject matter expert or other source, which may be used to annotate the clustered data.

In step 110, the annotated data is used as input to train a supervised large language model. Depending on the actual task to be solved, the annotated data is transformed in a way that it can be used to train a supervised learning model such as the LLM model illustrated in step 110. In the case of LLMs, there exist two known main strategies that can be used to solve a supervised learning task: fine-tuning or few-shot learning, either of which may be implemented in step 110 as will be understood by one of ordinary skill in the art.

In addition, since LLMs generally require a very large amount of resources to be trained, that directly affects their computational complexity and the needed amount of textual training data, it is also possible to use a checkpoint of the weights of a publicly available model as a starting point to train the LLM model in step 110. In this case, the LLM model of step 110 may be further trained from such publicly available LLM's as part of the ML pipeline illustrated in process 100, even though the original training process was optimized for another type of task and/or was conducted on textual data unrelated with the application domain. Indeed, one could choose the fine-tuning option, that is an example of transfer learning, and incorporated original model as the initial part of the LLM depicted in process 100 of FIG. 1.

Accordingly, the remaining part is typically optimized for solving the problem at hand (e.g., a sequence classification task based on the manifest files), and trained using domain-specific textual data. Such an approach may generally obtain impressive performance even though the amount of available data is small.

On the other hand, LLMs trained for causal language modeling (i.e., open-end text generation) are also capable of few-shot learning. This property consists in such a model being able to extrapolate how to solve a given learning task, provided that its description and a few input-output examples can be specified as a textual prompt (see the examples provided in Section 5). In this way, one does not even need to develop (and allocate resources for) a training pipeline, as the LLM is only used in inference mode.

As may be appreciated, one of the benefits of the pipeline as illustrated by process 100 in FIG. 1 is its flexibility in terms of implementation based on various desired criteria.

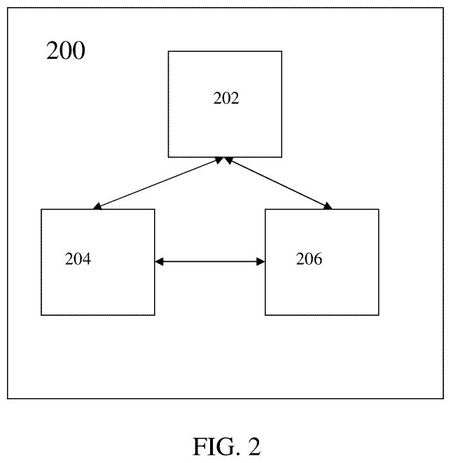

It will be appreciated that one or more aspects of the disclosure may be implemented using hardware, software, or a combination thereof. FIG. 2 depicts a high-level block diagram of an example processing device or apparatus 200 suitable for implementing one or more aspects of the disclosure, such as the ML pipeline process 100 illustrated in FIG. 1. Apparatus 200 comprises a processor 202 that is communicatively interconnected with various input/output devices 204 and a memory 206.

The processor 202 may be any type of processor such as a general-purpose central processing unit (“CPU”) or a dedicated microprocessor such as an embedded microcontroller or a digital signal processor (“DSP”). The input/output devices 204 may be any peripheral device operating under the control of the processor 202 and configured to input data into or output data from the apparatus 200 in accordance with the disclosure. The input/output devices 204 may also include conventional network adapters, data ports, and various user interface devices such as a keyboard, a keypad, a mouse, or a display.

Memory 206 may be any type of memory suitable for storing electronic information, including data and instructions executable by the processor 202. Memory 206 may be implemented as, for example, as one or more combinations of a random-access memory (RAM), read-only memory (ROM), flash memory, hard disk drive memory, compact-disk memory, optical memory, etc. In addition, apparatus 200 may also include an operating system, queue managers, device drivers, or one or more network protocols which may be stored, in one embodiment, in memory 206 and executed by the processor 202.

The memory 206 may include non-transitory memory storing executable instructions and data, which instructions, upon execution by the processor 202, may configure apparatus 200 to perform the functionality in accordance with the various aspects and steps described above. In some embodiments, the processor 202 may be configured, upon execution of the instructions, to communicate with, control, or implement all or a part of the functionality with respect to ML pipeline process described above. The processor may be configured to determine or receive a set of manifest files, extract features/characteristics from the manifest files, cluster the manifest files based on the determined features/characteristics as described above, enable and receive annotations/labels from a human subject matter expert or other source, and use the annotated/labeled data set to create/train a LLM model as illustrated in process 100 of FIG. 1.

In some embodiments, the processor 202 may also be configured to communicate with and/or control another apparatus 200 to which it is interconnected via, for example a network. In such cases, the functionality disclosed herein may be integrated into each standalone apparatus 200 or may be distributed between one or more apparatus 200. In some embodiments, the processor 202 may also be configured as a plurality of interconnected processors that are situated in different locations and communicatively interconnected with each other.

While a particular apparatus configuration is shown in FIG. 2, it will be appreciated that the present disclosure not limited to any particular implementation. For example, in some embodiments, all or a part of the functionality disclosed herein may be implemented using one or more application specific integrated circuits (ASICs), field programmable gate arrays (FPGAs), or the like.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

### Section 4

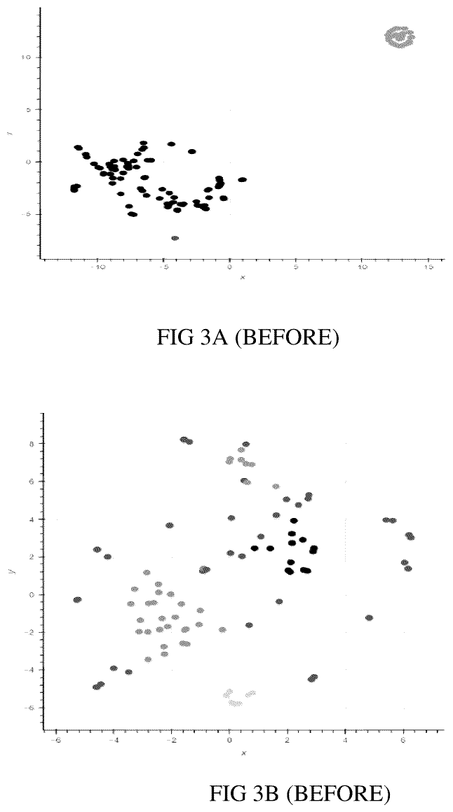

In order to validate the ideas presented in Section 3, the inventors developed some prototypes of the different parts of the proposed pipeline, and conducted some preliminary experiments considering a simplified version of our problem. Specifically, we gathered a set of ˜100 manifest files and ran our clustering pipeline on them. While our initial intent was to try and see whether the clustering output exposed interesting similarities that could be used to obtain a tentative data labeling, this step was particularly useful to filter out some noise from our data. FIG. 3a shows our initial clustering results. As described in Section 3, we obtained tf-idf-based representations of the manifests and used Principal Component Analysis (PCA) to get the top 10 dimensions, to limit the amount of data to be fed to HDBSCAN. After using t-SNE to project he clustered vectors in a 2D space, we observed that our data included a regularly-shaped cluster of manifests (in the top-right corner). Upon inspecting the corresponding manifests, we realized that their contents were not adding valuable information to our analysis. FIG. 3b reports the result we obtained by re-running the clustering pipeline after filtering out the uninteresting manifests. Given the limited dimension of our data sample, we were not able to use the clustering results to derive interesting annotations at this stage. Therefore, we decided to run Polaris on our manifests and considered the output of the (boolean) cpuLimitsMissing check, that reports whether CPU usage limits were correctly specified for Kubernetes resources like Deployment and Service. In this way, we were able to quickly obtain an annotated dataset, that allowed us to reduce our problem to a binary sequence classification task and conduct some experiments with LLMs. Given the impressive computational complexity of such models, we accelerated our experiments using the following GPUs:
NVIDIA Quadro RTX 6000 (Turing), 24 GB memory;
NVIDIA Quadro RTX 8000 (Turing), 48 GB memory.

In order to do that, we extensively leveraged on the HuggingFace transformers library (Wolf et al., 2020) and the pre-trained model checkpoints available on the associated model hub.3 Essentially, we focused our experiments on two LLMs: GPT-2 (medium)4 and GPT-J-6B.5 The medium-sized version of GPT-2 (Radford et al., 2019), consists of 355 M parameters, and accepts a maximum of 1024 tokens as input. During our few-shot learning tests, such an input token limit allowed us to provide just a couple of examples, as we had to save enough space for the actual input to be processed (see Section 5). Furthermore, given that the kind of outputs we obtained were not related in any way to the labels we specified in the prompt, we concluded that this model is not particularly suitable for declarative code analysis via few-shot learning. This is likely due to the fact that the model was trained on English natural language only, and probably never observed any code example. However, as we were able to run fine-tuning jobs even on our smaller GPU, we Speed (Rasley et al., 2020), 8 a framework that leverages on Zero Redundancy Optimizer (ZeRO) (Rajbhandari et al., 2020; Rajbhandari et al., 2021) to optimize model training memory footprint, either on a single or multiple GPUs, at the expense of speed. Setting up effective fine-tuning jobs, and properly assessing the resulting model performance, is still a work in progress. Contrary to few-shot learning tests, they require more, and better annotated, input data than a limited sample.

### Section 5

In this work, we proposed a method for analyzing declarative deployment code (specifically, Kubernetes deployment manifest files), such that non-expert developers can benefit from design patterns recommendations. To the best of our knowledge, our proposed approach is a novel way to address QA-related issues by specializing LLMs on declarative deployment code analysis. We conducted a preliminary validation of our ML pipeline on a simplified version of the problem, that shows that LLMs are indeed a viable and promising option for achieving our end goal. We plan to extend the approach beyond recommendations that can be obtained with standard static analysis tools (e.g., Polaris), by considering more convoluted design patterns and architectural smells (Carrasco et al., 2018; Neri et al., 2020), that involve a potentially large number of Kubernetes resources, possibly taking into account also security concerns (Ponce et al., 2022). In these regards, framing our problem as an extractive question-answering task seems a promising avenue. However, it would also be interesting to investigate the feasibility of a hybrid approach that combines LLMs with other types of models that can leverage on existing structures (e.g., relations among Kubernetes resources) in the input data, like Graph Neural Networks (Bacciu et al., 2020). We also plan to conduct a more thorough comparison of different types of LLMs and their usage modes (e.g., few-shot learning vs fine-tuning vs re-training). On a related note, it would be interesting to explore methods for deriving more compact representations of the inputs, to work around the maximum input tokens limit (e.g., YAML vs JSON encoding; optimize tokenizers for declarative code, similarly to the approach used for the natural language guided programming model proposed by (Heyman et al., 2021)). As Kubernetes is not the only cloud computing framework that leverages on declarative code for its configuration, we want to generalize our approach to other forms of deployment configuration files like, for instance, Heat Orchestration Templates for OpenStack. Finally, we believe it would be interesting to integrate active learning (Ren et al., 2021) techniques into our approach, to facilitate expert architects with sharing and embedding their knowledge into the underlying model.

### NUMERICAL REFERENCES

1 https://www.fairwinds.com/polaris
2 https://kubesec.io/
3 https://huggingface.co/models
4 https://huggingface.co/gpt2-medium
5 https://huggingface.co/EleutherAI/gpt-j-6B
6 https://www.eleuther.ai/
7 https://huggingface.co/blog/
hf-petabytes-integration

### CITATIONS

Alnafessah, A., Gias, A. U., Wang, R., Zhu, L., Casale, G., and Filieri, A. (2021). Quality-Aware DevOps Research: Where DoWe Stand? IEEE Access, 9:44476-44489.
Atanasova, P., Simonsen, J. G., Lioma, C., and Augenstein, I. (2020). A Diagnostic Study of Explainability Techniques for Text Classification. In Proceedings of the 2020 Conference on Empirical Methods in Natural Language Processing (EMNLP), pages 3256-3274. Association for Computational Linguistics.
Bacciu, D., Errica, F., Micheli, A., and Podda, M. (2020). A gentle introduction to deep learning for graphs. Neural Networks, 129:203-221.
Brown, T., Mann, B., Ryder, N., Subbiah, M., Kaplan, J. D., Dhariwal, P., Neelakantan, A., Shyam, P., Sastry, G., Askell, A., Agarwal, S., Herbert-Voss, A., Krueger, G., Henighan, T., Child, R., Ramesh, A., Ziegler, D., Wu, J., Winter, C., Hesse, C., Chen, M., Sigler, E., Litwin, M., Gray, S., Chess, B., Clark, J., Berner, C., McCandlish, S., Radford, A., Sutskever, I., and Amodei, D. (2020). Language Models are Few-Shot Learners. In Advances in Neural Information Processing Systems, volume 33, pages 1877-1901. Curran Associates, Inc.
Carrasco, A., Bladel, B. v., and Demeyer, S. (2018). Migrating towards microservices: migration and architecture smells. In Proceedings of the 2nd International Workshop on Refactoring, pages 1-6. Association for Computing Machinery.
Chen, M., Tworek, J., Jun, H., Yuan, Q., Pinto, H. P. d. O., Kaplan, J., Edwards, H., Burda, Y., Joseph, N., Brockman, G., Ray, A., Puri, R., Krueger, G., Petrov, M., Khlaaf, H., Sastry, G., Mishkin, P., Chan, B., Gray, S., Ryder, N., Pavlov, M., Power, A., Kaiser, L., Bavarian, M., Winter, C., Tillet, P., Such, F. P., Cummings, D., Plappert, M., Chantzis, F., Barnes, E., Herbert-Voss, A., Guss, W. H., Nichol, A., Paino, A., Tezak, N., Tang, J., Babuschkin, I., Balaji, S., Jain, S., Saunders, W., Hesse, C., Carr, A. N., Leike, J., Achiam, J., Misra, V., Morikawa, E., Radford, A., Knight, M., Brundage, M., Murati, M., Mayer, K., Welinder, P., McGrew, B., Amodei, D., McCandlish, S., Sutskever, I., and Zaremba, W. (2021). Evaluating Large Language Models Trained on Code.
Demirci, D., s ̧ahin, N., s ̧irlancis, M., and Acarturk, C. (2022). Static Malware Detection Using Stacked BiLSTM and GPT-2. IEEE Access, 10:58488-58502.
Dettmers, T., Lewis, M., Belkada, Y., and Zettlemoyer, L. (2022). LLM.int8(): 8-bit Matrix Multiplication for Transformers at Scale.
Gao, L., Biderman, S., Black, S., Golding, L., Hoppe, T., Foster, C., Phang, J., He, H., Thite, A., Nabeshima, N., Presser, S., and Leahy, C. (2020). The Pile: An 800GB Dataset of Diverse Text for Language Modeling.
Heyman, G., Huysegems, R., Justen, P., and Van Cutsem, T. (2021). Natural language-guided programming. In Proceedings of the 2021 ACM SIGPLAN International Symposium on New Ideas, New Paradigms, and Reflections on Programming and Software, pages 39-55. Association for Computing Machinery.
Hoover, B., Strobelt, H., and Gehrmann, S. (2020). exBERT: A Visual Analysis Tool to Explore Learned Representations in Transformer Models. In Proceedings of the 58th Annual Meeting of the Association for Computational Linguistics: System Demonstrations, pages 187-196. Association for Computational Linguistics.
Jain, N., Vaidyanath, S., Iyer, A., Natarajan, N., Parthasarathy, S., Rajamani, S., and Sharma, R. (2022). Jigsaw: large language models meet program synthesis. In Proceedings of the 44th International Conference on Software Engineering, pages 1219-1231. Association for Computing Machinery.
Li, R., Soliman, M., Liang, P., and Avgeriou, P. (2022). Symptoms of Architecture Erosion in Code Reviews: A Study of Two OpenStack Projects. In 2022 IEEE 19th International Conference on Software Architecture (ICSA), pages 24-35.
Ma, W., Zhao, M., Xie, X., Hu, Q., Liu, S., Zhang, J., Wang, W., and Liu, Y. (2022). Is Self-Attention Powerful to Learn Code Syntax and Semantics?
Maaten, L. v. d. and Hinton, G. (2008). Visualizing Data using t-SNE. Journal of Machine Learning Research, 9(86):2579-2605.
MacNeil, S., Tran, A., Mogil, D., Bernstein, S., Ross, E., and Huang, Z. (2022). Generating Diverse Code Explanations using the GPT-3 Large Language Model. In Proceedings of the 2022 ACM Conference on International Computing Education Research—Volume 2, volume 2, pages 37-39. Association for Computing Machinery.
McInnes, L. and Healy, J. (2017). Accelerated Hierarchical Density Based Clustering. In 2017 IEEE International Conference on Data Mining Workshops (ICDMW), pages 33-42.
Mumtaz, H., Singh, P., and Blincoe, K. (2021). A systematic mapping study on architectural smells detection. Journal of Systems and Software, 173:110885.
Neri, D., Soldani, J., Zimmermann, O., and Brogi, A. (2020). Design principles, architectural smells and refactorings for microservices: a multivocal review. SICS Software-Intensive Cyber-Physical Systems, 35(1):3-15.
Ponce, F., Soldani, J., Astudillo, H., and Brogi, A. (2022). Smells and refactorings for microservices security: A multivocal literature review. Journal of Systems and Software, 192:111393.
Radford, A., Narasimhan, K., Salimans, T., and Sutskever, I. (2018). Improving Language Understanding by Generative Pre-Training. Technical report.
Radford, A., Wu, J., Child, R., Luan, D., Amodei, D., and Sutskever, I. (2019). Language models are unsupervised multitask learners.
Rajaraman, A. and Ullman, J. D. (2011). Data Mining. In Mining of Massive Datasets, pages 1-17. Cambridge University Press.
Rajbhandari, S., Rasley, J., Ruwase, O., and He, Y. (2020). ZeRO: memory optimizations toward training trillion parameter models. In Proceedings of the International Conference for High Performance Computing, Networking, Storage and Analysis, pages 1-16. IEEE Press.
Rajbhandari, S., Ruwase, O., Rasley, J., Smith, S., and He, Y. (2021). ZeRO-infinity: breaking the GPU memory wall for extreme scale deep learning. In Proceedings of the International Conference for High Performance Computing, Networking, Storage and Analysis, pages 1-14. Association for Computing Machinery.
Rasley, J., Rajbhandari, S., Ruwase, O., and He, Y. (2020). DeepSpeed: System Optimizations Enable Training Deep Learning Models with Over 100 Billion Parameters. In Proceedings of the 26th ACM SIGKDD International Conference on Knowledge Discovery & Data Mining, pages 3505-3506. Association for Computing Machinery.
Ren, P., Xiao, Y., Chang, X., Huang, P.-Y., Li, Z., Gupta, B. B., Chen, X., and Wang, X. (2021). A Survey of Deep Active Learning. ACM Computing Surveys, 54(9):180:1-180:40.
Sarsa, S., Denny, P., Hellas, A., and Leinonen, J. (2022). Automatic Generation of Programming Exercises and Code Explanations Using Large Language Models. In Proceedings of the 2022 ACM Conference on International Computing Education Research—Volume 1, volume 1, pages 27-43. Association for Computing Machinery.
Sharma, T., Kechagia, M., Georgiou, S., Tiwari, R., and Sarro, F. (2021). A Survey on Machine Learning Techniques for Source Code Analysis.
Shorten, C. and Khoshgoftaar, T. M. (2023). Language Models for Deep Learning Programming: A Case Study with Keras. In Wani, M. A. and Palade, V., editors, Deep Learning Applications, Volume 4, pages 135-161. Springer Nature.
Sontakke, A. N., Patwardhan, M., Vig, L., Medicherla, R. K., Naik, R., and Shroff, G. (2022). Code Summarization: Do Transformers Really Understand Code? In Deep Learning for Code Workshop.
Tenney, I., Wexler, J., Bastings, J., Bolukbasi, T., Coenen, A., Gehrmann, S., Jiang, E., Pushkarna, M., Radebaugh, C., Reif, E., and Yuan, A. (2020). The Language Interpretability Tool: Extensible, Interactive Visualizations and Analysis for NLP Models. In Proceedings of the 2020 Conference on Empirical Methods in Natural Language Processing: System Demonstrations, pages 107-118. Association for Computational Linguistics.
Thapa, C., Jang, S. I., Ahmed, M. E., Camtepe, S., Pieprzyk, J., and Nepal, S. (2022). Transformer-Based Language Models for Software Vulnerability Detection. In Proceedings of the 38th Annual Computer Security Applications Conference, pages 481-496. Association for Computing Machinery.
Vaswani, A., Shazeer, N., Parmar, N., Uszkoreit, J., Jones, L., Gomez, A. N., Kaiser, L., and Polosukhin, I. (2017). Attention is All you Need. In Advances in Neural Information Processing Systems, volume 30. Curran Associates, Inc.
Wan, Y., Zhao, W., Zhang, H., Sui, Y., Xu, G., and Jin, H. (2022). What do they capture? a structural analysis of pre-trained language models for source code. In Proceedings of the 44th International Conference on Software Engineering, pages 2377-2388. Association for Computing Machinery.
Wolf, T., Debut, L., Sanh, V., Chaumond, J., Delangue, C., Moi, A., Cistac, P., Rault, T., Louf, R., Funtowicz, M., Davison, J., Shleifer, S., von Platen, P., Ma, C., Jernite, Y., Plu, J., Xu, C., Le Scao, T., Gugger, S., Drame, M., Lhoest, Q., and Rush, A. (2020). Transformers: State-of-the-Art Natural Language Processing. In Proceedings of the 2020 Conference on Empirical Methods in Natural Language Processing: System Demonstrations, pages 38-45. Association for Computational Linguistics.
Zhang, J., Mytkowicz, T., Kaufman, M., Piskac, R., and Lahiri, S. K. (2021). Can Pre-trained Language Models be Used to Resolve Textual and Semantic Merge Conflicts?

1. An apparatus comprising:
at least one processor; and
at least one memory storing instructions that, when executed by the at least one processor, cause at least:
extracting a dataset of one of more features from a set of manifest files for deploying at least one resource in a cloud network environment;
clustering the dataset of one of more features extracted from the set of manifest files;
labelling the clustered dataset of the one or more features extracted from the manifest files; and
using the labeled dataset to train a large language machine learning model.

2. The apparatus of claim 1, wherein at least a first feature of the one or more features classifies a quality of at least one manifest file in the set of manifest files.

3. The apparatus of claim 1, wherein at least a second feature of the one or more features indicates which features extracted from at least one manifest file in the set of manifest files contribute to an outcome of a classification performed by the large language machine learning model.

4. The apparatus of claim 1, wherein at least a third feature of the one or more features extracted from at least one manifest file in the set of manifest files indicates a design problem and/or a recommended suitable fix for the design problem associated with the at least one manifest file.

5. The apparatus of claim 1, wherein at least a third fourth feature of the one or more features extracted from at least one manifest file indicates one or more relations among components of the at least one resource deployed in the cloud network environment.

6. The apparatus of claim 1, wherein at least a first manifest file from the set of manifest files is used to deploy the at least one resource comprising an application or a service in the cloud network environment.

7. The apparatus of claim 1, wherein the clustering of the dataset of one of more features uses unsupervised clustering.

8. The apparatus of claim 1, wherein the labelling further comprises receiving an initial set of one or more annotations to label at least a portion of the clustered dataset.

9. The apparatus of claim 1, wherein the labeled dataset uses at least in part supervised learning to train the large language machine learning model.

10. An method comprising:
extracting a dataset of one of more features from a set of manifest files for deploying at least one resource in a cloud network environment;
clustering the dataset of one of more features extracted from the set of manifest files;
labelling the clustered dataset of the one or more features extracted from the manifest files; and
using the labeled dataset to train a large language machine learning model.

11. The method of claim 10, wherein at least a first feature of the one or more features classifies a quality of at least one manifest file in the set of manifest files.

12. The method of claim 10, wherein at least a second feature of the one or more features indicates which features extracted from at least one manifest file in the set of manifest files contribute to an outcome of a classification performed by the large language machine learning model.

13. The method of claim 10, wherein at least a third feature of the one or more features extracted from at least one manifest file in the set of manifest files indicates a design problem and/or a recommended suitable fix for the design problem associated with the at least one manifest file.

14. The method of claim 10, wherein at least a third fourth feature of the one or more features extracted from at least one manifest file indicates one or more relations among components of the at least one resource deployed in the cloud network environment.

15. The method of claim 10, wherein at least a first manifest file from the set of manifest files is used to deploy the at least one resource comprising an application or a service in the cloud network environment.

16. The method of claim 10, wherein the clustering of the dataset of one of more features uses unsupervised clustering.

17. The method of claim 10, wherein the labelling further comprises receiving an initial set of one or more annotations to label at least a portion of the clustered dataset.

18. The method of claim 10, wherein the labeled dataset uses at least in part supervised learning to train the large language machine learning model.

19. A non-transitory computer-readable storage storing instructions that, when executed by at least one processor, cause at least:
extracting a dataset of one of more features from a set of manifest files for deploying at least one resource in a cloud network environment;
clustering the dataset of one of more features extracted from the set of manifest files;
labelling the clustered dataset of the one or more features extracted from the manifest files; and
using the labeled dataset to train a large language machine learning model.
